(19) United States
(12) Patent Application Publication
(10) Pub. No.: US 2015/0211268 A1
(43) Pub. Date: Jul. 30, 2015

(54) Spring Operated Doorstop with Foot Release

(71) Applicant: George F. Lott, Fredericksburg, TX (US)

(72) Inventor: George F. Lott, Fredericksburg, TX (US)

(21) Appl. No.: 14/166,266

(22) Filed: Jan. 28, 2014

(51) Int. Cl. E05C 17/02

(52) U.S. Cl. CPC E05C 17/02

(57) ABSTRACT

A spring-operated doorstop for holding a door in an open position. The doorstop has a flat thin base plate for permanent attachment on a floor, and a top plate hinged to the base plate. A spring holds the top plate apart from the base plate, such that when the spring is in a non-compressed state, the angle between the base plate and the top plate is a set angle. A foot pedal is rigidly attached to the top plate. The doorstop is installed near the wall with the hinge facing outward, so that when the door is opened toward the wall and over the door stop, the spring momentarily compresses. It then springs back, so that the top plate will prevent the door from unwanted re-closing. The foot pedal may be used to hold the top plate down when the door is desired to be closed.

### TECHNICAL FIELD OF THE INVENTION

This invention relates to stops for holding doors open, and more particularly to floor-mounted door stops.

### BACKGROUND OF THE INVENTION

In the most general sense, a “doorstop” can be any one of various objects or devices used to hold a door open or closed, or to prevent a door from opening too widely.

To hold a door open, the door stop may simply be a heavy solid object placed in the path of the door. These objects can range from spontaneously improvised objects, chosen simply because they are heavy, to artistic or whimsical designs.

Another type of doorstop is the ubiquitous wedge-type door stop, which is a small wedge of wood, rubber, plastic, or other material. Manufactured wedges of these materials are commonly available. The wedge is kicked into position and the downward force of the door, now jammed upwards onto the doorstop, provides enough static friction to keep it motionless.

A third strategy is to equip the door with a stopping mechanism. One such device is a short metal bar capped with rubber, or other high friction material, vertically hinged near the bottom edge of the door on the side that swings open and shut. When the door is to be kept open, the bar is swung down so that the rubber end touches the floor, and the bar braces the door open. When the door is to be closed, the stop is released by pushing the door slightly more open which allows the metal bar to be flipped upwards. Another example of a door stop device is a magnet attached to the bottom of the door. When the door is open, the magnet on the door attaches to another magnet on the wall or to a small hub on the floor. The magnet is strong enough to hold the weight of the door, but weak enough to be easily pulled from the wall or hub.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a perspective view of the doorstop, along the length of its hinged side and in its open position.

FIG. 2 is a perspective view of the doorstop, along the length of its non-hinged side and in its open position.

FIG. 3 is another perspective view of the doorstop, viewed from the opposite end as FIGS. 1 and 2.

FIG. 4 illustrates how the closing of a door over the doorstop causes the top plate to press down against the base plate.

FIG. 5 illustrates the doorstop attached to a floor, in its open position, holding a door open against or close to a wall.

FIGS. 6 and 7 are perspective views of the installation and operation of the doorstop.

FIGS. 8 and 9 are top views of the installation and operation of the doorstop.

### DETAILED DESCRIPTION OF THE INVENTION

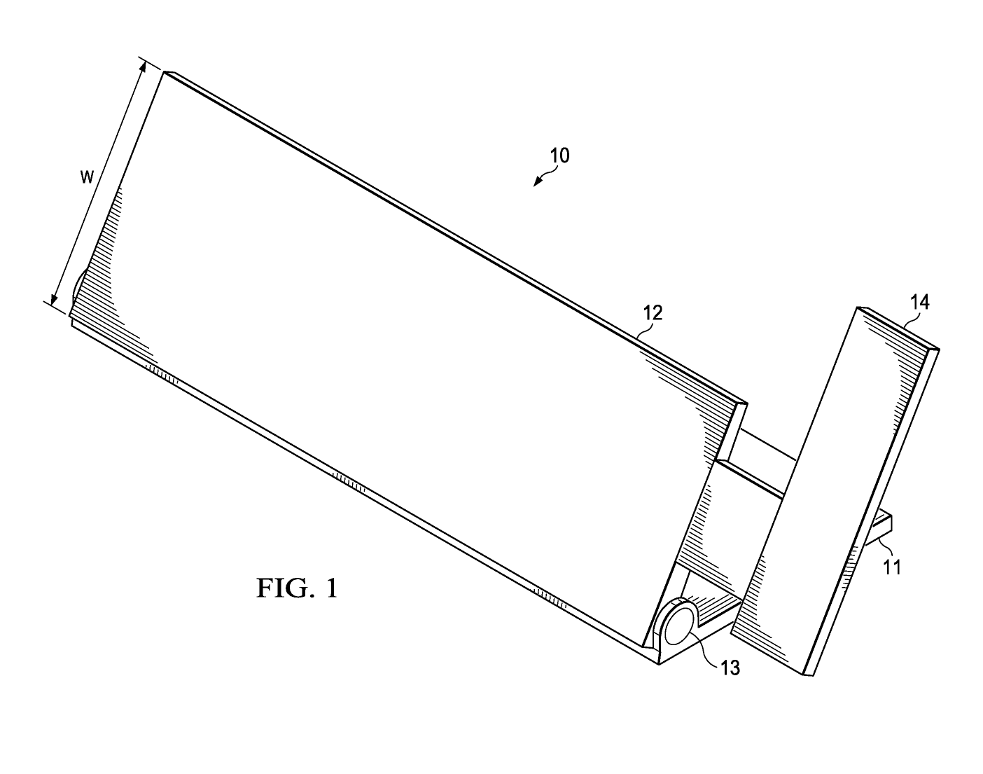

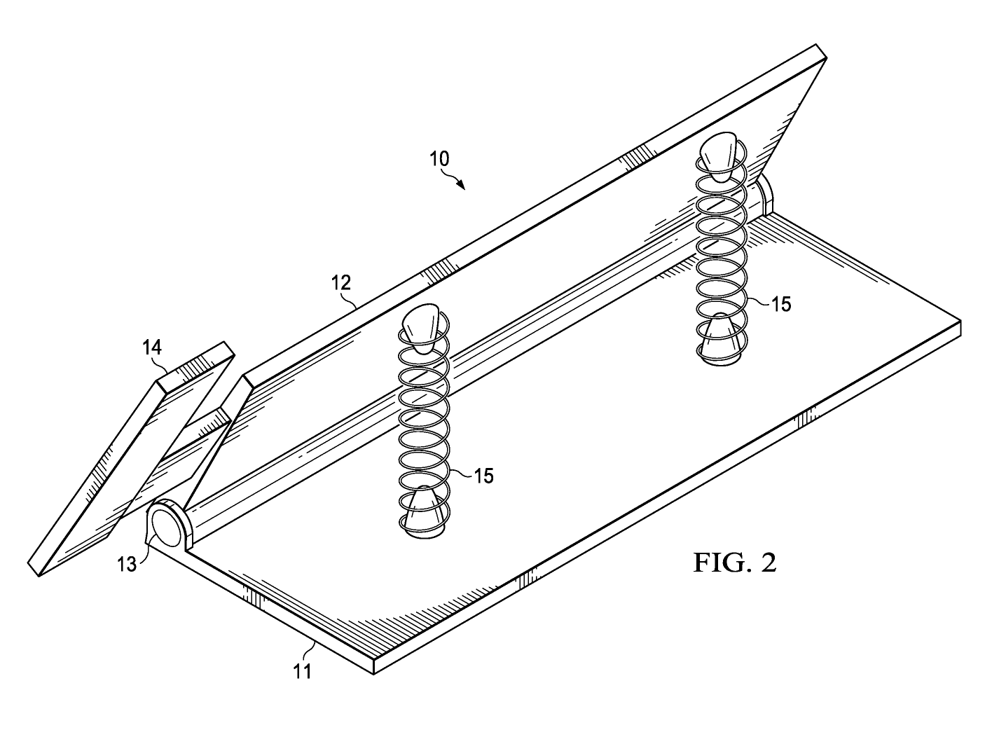

FIGS. 1 and 2 are both perspective views of the doorstop 10, as viewed from its hinged and non-hinged sides, respectively. FIG. 1 illustrates the doorstop 10 viewed from its hinged side, whereas FIG. 2 illustrates the doorstop 10 from its non-hinged (open) side. In both FIGS. 1 and 2, the doorstop 10 is in its “normally open” position.

Doorstop 10 comprises a base plate 11, top plate 12, hinge 13, foot pedal 14, and spring 15. Hinge 13 attaches a straight edge of base plate 11 to a straight edge of top plate 12.

Spring 15 holds top plate 12 apart from base plate 11, when doorstop 10 is in its open position. In other words, spring 15 provides a spring force that pushes top plate 12 apart from bottom plate 11. The size and spring force of spring 15 may vary, but generally spring 15 is configured to hold doorstop 10 in the “normally open” position of FIGS. 1-3.

In the example of FIGS. 1 and 2, spring 15 is a compression spring, but various types of springs may be suitable, such as torsion or leaf springs. More than one spring may be used. “Spring” is meant herein in its most general sense to mean any resilient device, not limited to a helical metal coil, that can be pressed or pulled but returns to its former shape when released, used to exert tension or absorb movement. In the present application, the spring 15 is a “tension device” used to exert tension to hold doorstop 10 in its open position, unless compressed.

As explained below, as a door is opened and passes over doorstop 10, spring 15 compresses so as to allow the door to push down on, and pass over, top plate 12. Spring 15 then returns top plate 123 to its open position, thereby holding the door open.

Foot pedal 14 extends from top plate 14, with a rigid attachment to top plate 12. Thus, pressing foot pedal 14 downward toward will result in closing top plate 12 against base plate 11.

Base plate 11 is flat and planar, and suitable for permanent attachment to a floor. Various attachment means may be used, such as screws or glue, or any other means that does not impede the closing action of top plate 12 against base plate 11 when spring 15 is compressed.

The particular placement of doorstop 10 on a floor, relative to a door is discussed below. The attachment means for securing doorstop 10 to the floor may be by any suitable means, and may depend on the characteristics of the door being held open. That is, a heavier door may require a more robust attachment. In general, the attachment may be by any means that allows doorstop 10 be securely held to the floor so as to hold a door open when doorstop 10 is in operation.

Attachment means may also depend on the type of floor. For some floors and doors, attachment such as by screws into the floor may be required. For other floor and/or door configurations, attachment such as by a “hook and loop” strips on the floor and on the bottom of base plate 11 may be suitable. Other possible attachment means may include, without limitation, glue or other adhesive.

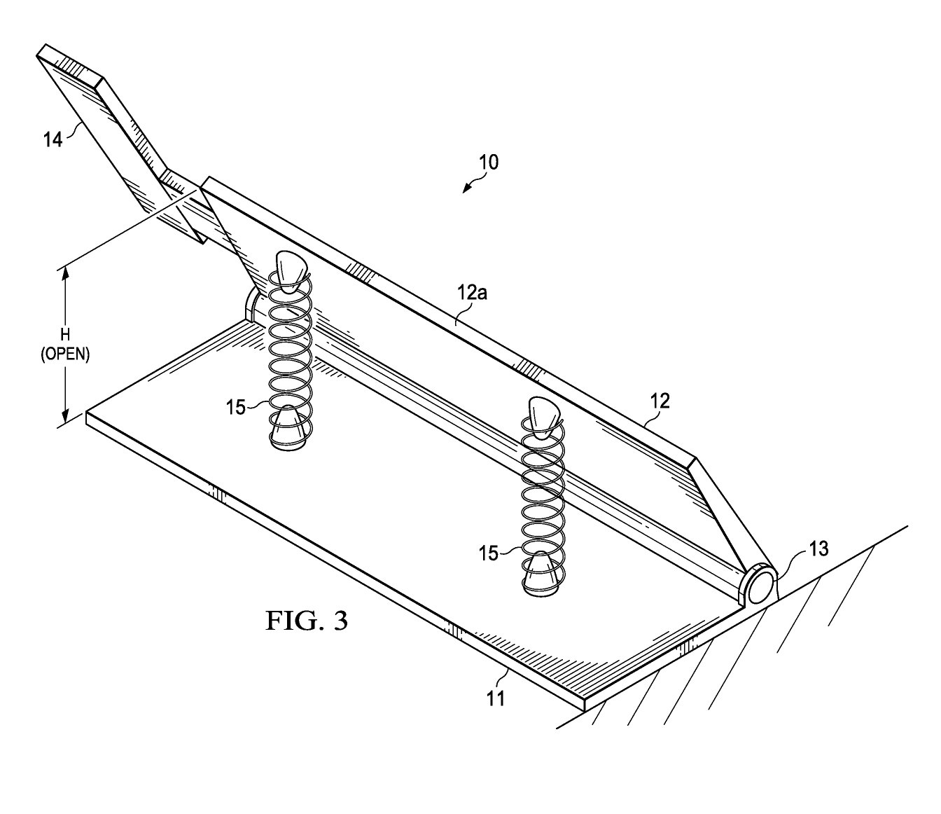

FIG. 3 is another perspective view of doorstop 10, viewed from the opposite end as FIGS. 1 and 2. As explained below, when doorstop 10 is installed on a floor, the end shown in FIG. 3 points generally toward the door hinge, and may thus be referred to as the “door” end of doorstop 10. Thus, FIGS. 1 and 2 illustrate doorstop from its “foot pedal end”, whereas FIG. 3 illustrates doorstop 10 from its “door end”.

In FIGS. 1-3, the normally open position of doorstop 10 results in an angle between bottom plate 11 and top plate 12 of about 60 degrees. In general, spring 15 is sized and otherwise operable so that the open angle between base plate 11 and top plate 12 is a set angle, which typically ranges between 30 and 90 degrees. When compressed, spring 15 allows top plate 12 to be pressed against base plate 11, such that the angle between them is minimal (close to zero degrees).

The width, W, of top plate 12 and the open angle between top plate 12 and base plate 11 are designed to that the top edge 12a of top plate 12 will be at sufficient height (H-open) such that doorstop will operate properly given the space (clearance) between the bottom of the door and the floor.

Referring to FIGS. 1-3, bottom plate 11, top plate 12 and foot pedal 13 may be made from various rigid materials. Typical materials are metals and hard plastics.

Base plate 11 and top plate 12 are planar and relatively thin. Although they need not be the same thickness, a typical thickness is in the range of ¼ to ½ inch. For example, if both base plate 11 and top plate 12 are less than ½ inch thick, when spring 15 is compressed, and top plate 12 lies against base plate 11, the total thickness is not much more than 1 inch. This allows a door to open or close across the doorstop 10.

In various embodiments, top plate 12 and foot pedal 14 could be manufactured as one piece or two. In FIGS. 1-3, foot pedal 14 is shown as having a bridged attachment to top plate 12. As explained below, foot pedal 14 extends beyond the width of the door when doorstop 10 is installed for operation. Other embodiments could include a top plate 12 that simply has a longer and possibly thicker (wider) portion at one end to form foot pedal 14.

Hinge 13 may be attached to, or integrated with, base plate 11 and/or top plate 12. In one embodiment, hinge 13 could be configured similarly to a butt hinge, that is, as two plates, each with a series of alternating cylinders through which is positioned a round bar. In fact, base plate 11, top plate 12, and hinge 13 could be integrated, such that these three elements are configured as in a common butt hinge. Other hinges, such as barrel or piano type hinges, may also be suitable. “Hinge” is meant here in the most general sense, to mean any attachment mechanism that allows the angle between base plate 11 and top plate 12 to vary between approximately zero and ninety degrees.

The perimeter geometries of base plate 11 and top plate 12 may vary. Base plate 11 and top plate 12 may have different shapes. In the examples of this description, both are have rectangular geometries and are the same size. As a result, both have a long straight side of the same length, and a long side of top plate 12 is attached by hinge 14 to a long side of base plate 11. Typically, top plate 12 will have a second long straight side, against which the flat surface of a door may abut when being held closed. Other suitable geometries, especially for base plate 11 because its main function is to attach to top plate 12 with a hinge and to provide secure attachment of doorstop 10 to a floor, may be triangular or semicircular.

A typical overall length, L, of doorstop 10 is in the range of 4-6 inches (not including foot pedal 14). A typical width, W, is between 2 and 4 inches. If the “longitudinal” axis of doorstop 10 is considered to be along to direction of hinge 13, door pedal 14 will extend from top plate 12 along that direction.

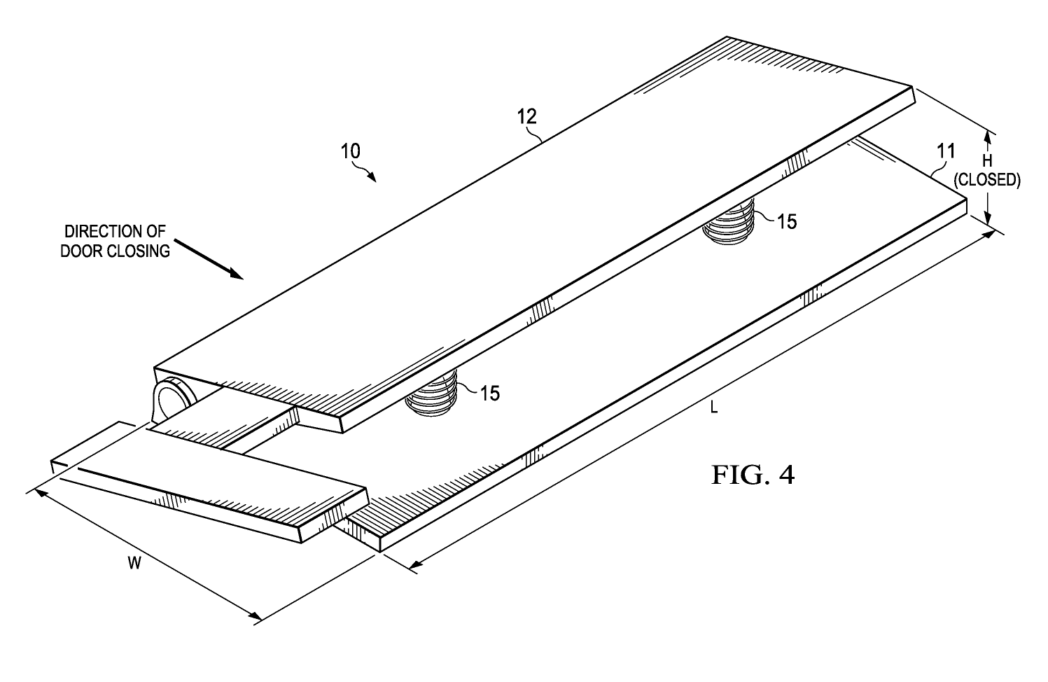

FIG. 4 illustrates how the closing of a door over doorstop 10 causes top plate 12 to press down against base plate 11. In this “closed” position of doorstop 10, with spring 15 compressed, top plate 12 is pressed down against base plate 11.

As the door passes over doorstop 10, the force of the door pressing against the top plate 12 causes the angle between top plate 12 and bottom plate 11 to decrease. This allows the door to pass over and past the doorstop 10. In the example of FIG. 4, the thickness (height) of doorstop 10 is a maximum of H-closed. As explained below, this height is related to the clearance between the door and the floor.

Because the door closes toward the hinged attachment 13, the action of the door being closed automatically results in closing doorstop 10. In other words, the door presses against top plate 12, and closes the angle between top plate 12 and base plate 12. Because of spring 15, after the door passes over doorstop 10, doorstop 10 returns to its open position.

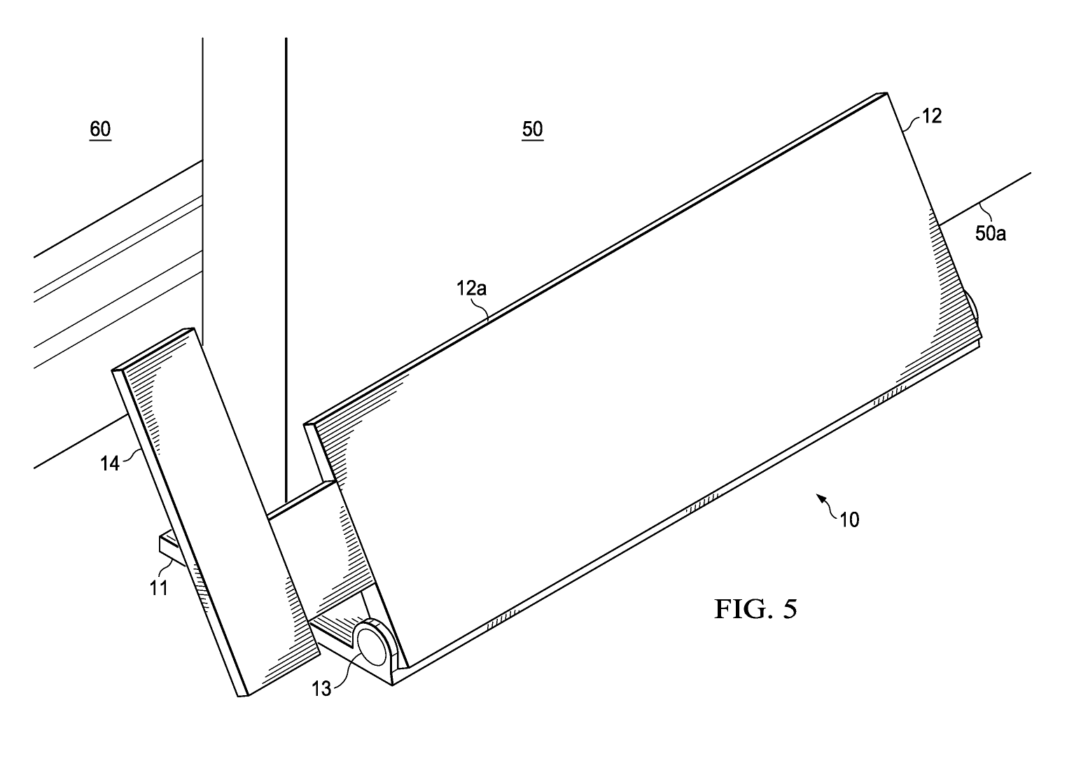

FIG. 5 illustrates doorstop 10 attached to a floor, in its open position, holding a door 50 open against or close to a wall 60. The hinged side of doorstop 10 faces outward from the wall 60. Door 50 has been opened toward and over doorstop 10, thereby pushing top plate 11 downward toward base plate 11, as explained above in connection with FIG. 4. This action results in compressing spring 15, which is not visible in FIG. 5.

After door 50 has passed over doorstop 10, spring 15 pushes top plate 12 upward back into its open position. The top edge 12a of top plate 12 is a greater distance from the floor than the bottom edge 50a of door 50. As a result, door 50 is held open by top plate 12 and will not move past doorstop 10.

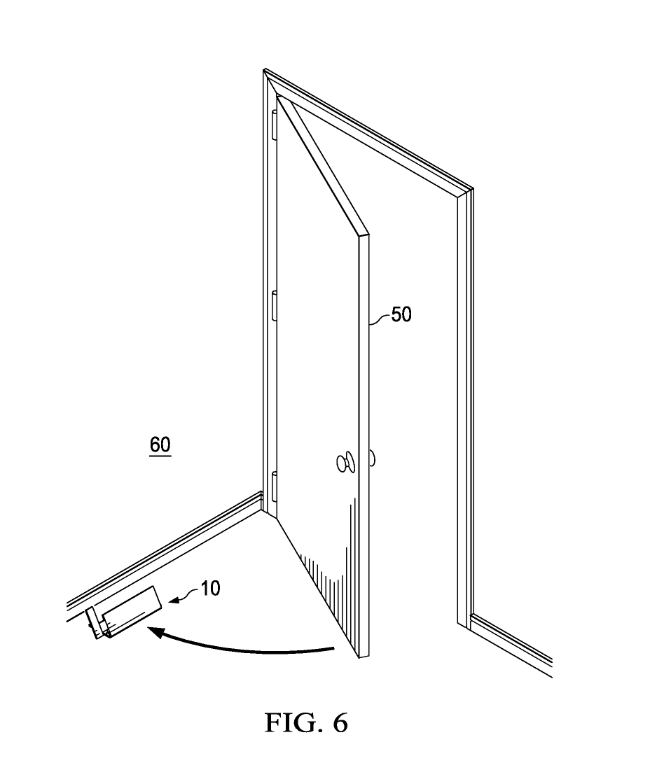

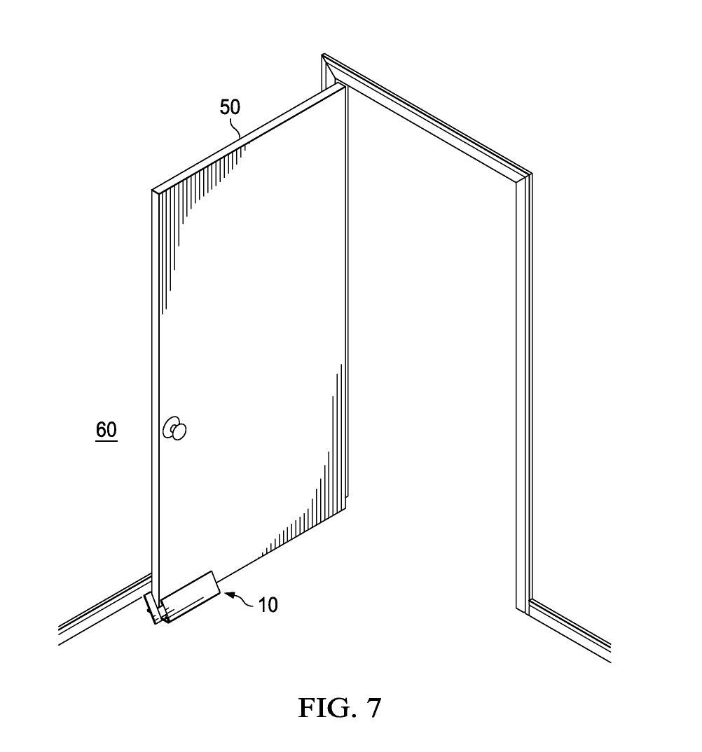

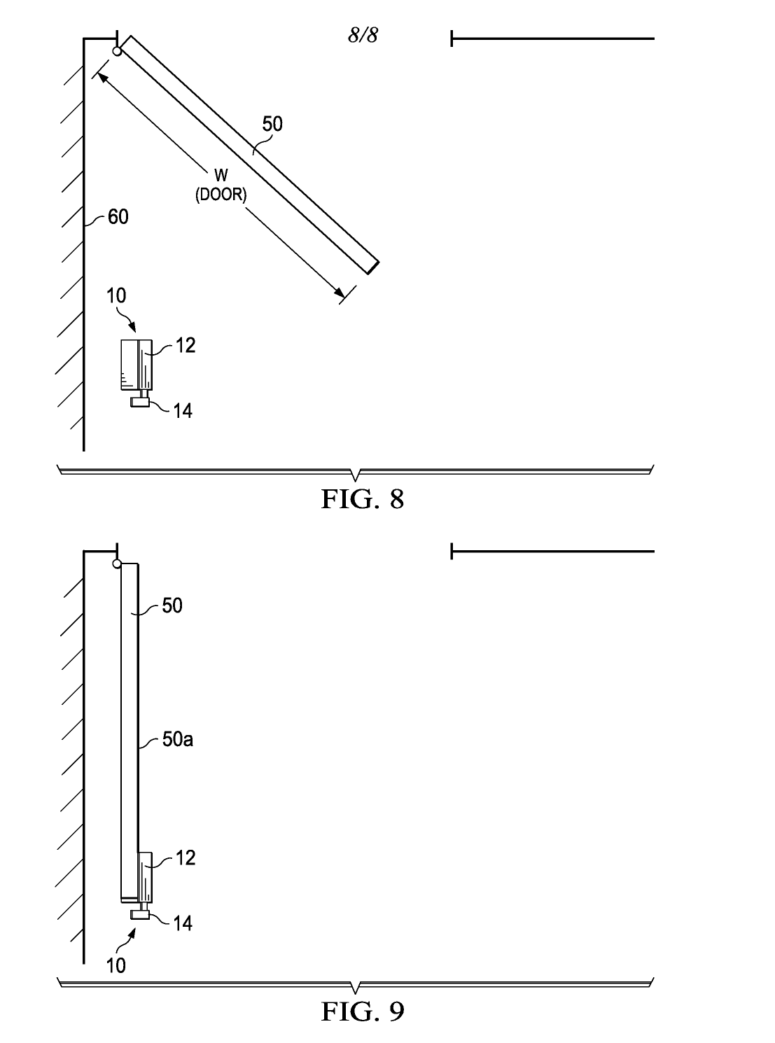

FIGS. 6-9 further illustrate the installation and operation of doorstop 10. FIGS. 6 and 7 are perspective views, and FIGS. 8 and 9 are top views.

Doorstop 10 is securely attached to a floor, as described above, with base plate 11 being attached flat against the floor.

Doorstop 10 is placed near a wall 60 against which the door 50 will open. The sides of doorstop 10 are generally parallel to wall 60, but may be angled slightly outward to correspond to the angle of door 50 when it is opened to a desired distance from the wall. Other words, the more closely door 50 is to be held open against the wall 50, the more parallel will be the position of doorstop 10 relative to wall 60. Also, depending how close door is desired to be held against wall 60, the distance between doorstop 10 and wall 50 may vary.

In FIGS. 6 and 8, door 50 is partly closed, whereas in FIGS. 7 and 9, door 50 is open and being held in place by doorstop 10. Because of the manner in which door 50 is hung, there is clearance between the bottom of door 50 and the floor. Doorstop 10 has a maximum height (H-closed in FIG. 4) in its closed position, which is less than the clearance between the bottom edge 50a of the door and the floor. Thus, when doorstop 10 is in its closed position, door 50 may pass over the top of doorstop 10.

However, during opening of the door, once door 50 passes over doorstop 10, doorstop 10 automatically resumes its open position, due to the action of spring 15. In this open position, the top edge 12a of top plate 12 has a height that is greater than the distance between the bottom edge 50a of door 50 and the surface of the floor. This height (H-open in FIG. 3) results in top plate 12 being sufficiently high so that at least the top edge of top plate 12 rests against the door to hold the door open.

As shown in FIG. 9, doorstop is installed such that when doorstop 10 is holding door 50 open, foot pedal 14 extends past the outer edge 50a of door 50. This allows a person to simply use his or her foot to press down on foot pedal 14 when door 50 is desired to be closed. By pressing down on foot pedal 14, top plate 12 is pressed down against base plate 11, compressing spring 15. The now-reduced height of doorstop 10 allows the door to pass over doorstop 10 and to be swung closed.

A feature of doorstop 10 is that it is normally in its open position. As explained above, it is pressed closed by a door when the door is passing over it while the door is being opened, but springs back open once the door passes over it. Also, doorstop 10 becomes closed when the door is desired to be closed and foot pedal 14 is pressed down, to allow the door to pass over it and be thereby closed.

It should also be understood that in the example of this description, the door is to be closed against a wall and thus doorstop is installed close to the wall.

However, applications are imaginable in which a door may be desired to be held open but not necessarily against a wall.

What is claimed is:

1. A doorstop for holding a door in an open position, the door being hung such that there is a gap between the bottom of the door and a floor, the doorstop comprising:
a flat thin base plate for permanent attachment flat on the floor;
wherein the base plate has at least one straight side;
a top plate;
wherein the top plate has at least one straight side generally corresponding in length to the at least one straight side of the base plate;
a hinge for attaching a straight side of the base plate and a straight side of the top plate;
at least one tension device for holding the top plate apart from the base plate, such that when the base plate is attached to the floor and the tension device is not compressed, the angle between the base plate and the top plate is a set angle between thirty and ninety degrees; and
a foot pedal rigidly attached to the top plate.

2. The doorstop of claim 1, wherein the base plate is generally rectangular in shape.

3. The doorstop of claim 1, wherein the top plate is generally rectangular in shape.

4. The doorstop of claim 1, wherein the hinge is a butt type hinge.

5. The doorstop of claim 1, wherein the base plate, top plate and hinge are integrated as a butt type hinge.

6. The doorstop of claim 1, wherein the tension device is one or more helical springs.

7. A method of using a spring-operated doorstop for holding a door in an open position, the door being hung such that there is a gap between the bottom of the door and a floor, comprising:
attaching a doorstop to the floor, the doorstop having at least a flat thin base plate for permanent attachment flat on the floor; wherein the base plate has at least one straight side; a top plate; wherein the top plate has at least one straight side generally corresponding in length to the at least one straight side of the base plate; a hinge for attaching a straight side of the base plate and a straight side of the top plate; at least one tension device for holding the top plate apart from the base plate, such that when the base plate is attached to the floor and the tension device is not compressed, the angle between the base plate and the top plate is a set angle between thirty and ninety degrees; and a foot pedal rigidly attached to the top plate;
wherein the attaching step is performed such that the hinged side of the doorstop faces away from the wall, and the doorstop is located a distance from the wall corresponding to the desired position of the door when held open; and
opening the door across the top of the doorstop such that the hinge momentarily compresses due to the force of the door.

8. The method of claim 7, wherein the base plate is generally rectangular in shape.

9. The method of claim 7, wherein the top plate is generally rectangular in shape.

10. The method of claim 7, wherein the hinge is a butt type hinge.

11. The method of claim 7, wherein the base plate, top plate and hinge are integrated as a butt type hinge.

12. The method of claim 7, further comprising pressing down on the foot pedal when the door is desired to be closed, such that the door may pass over the doorstop.

13. The method of claim 7, wherein the tension device is one or more helical springs.
